(19) United States
(12) Patent Application Publication
(10) Pub. No.: US 2026/0303519 A1
(43) Pub. Date: Oct. 1, 2026

(54) COMPUTE PLATFORM BASED AP SWITCHING

(71) Applicant: Intel Corporation, Santa Clara, CA (US)

(72) Inventors: Ilan HAMAMI, Tel Mond (IL); Kobi GUETTA, Netanya (IL); Yoni KAHANA, Kfar Hess (IL); Coral KUTA, Rosh HaAyin (IL)

(21) Appl. No.: 19/090,990

(22) Filed: Mar. 26, 2025

(51) Int. Cl. H04L 45/302; H04L 43/0811; H04L 45/00; H04W 40/14; H04W 76/19; H04W 84/12

(52) U.S. Cl. CPC H04L 45/306; H04L 43/0811; H04L 45/22; H04W 40/14; H04W 76/19; H04W 84/12

(57) ABSTRACT

Techniques may be provided to facilitate rapid automatic access point (AP) steering and reverting between APs based on efficiently determining AP connection failure.

### BACKGROUND

The selection of an access point (AP) from various networks is typically based on multiple network parameters to ensure quality performance. However, the AP itself or the surrounding environment may cause clients to be disconnected from the internet. In many cases, there are alternate access point options available, but with existing schemes, it can take excessive time for access point switches to be made by a client compute platform (e.g., PC, mobile handset, or other compute platform).

Current solutions typically require several seconds to identify a disconnection and steer to a different network, and additional time is needed to revert if necessary, using common OS commands (such as trace) to detect the lack of connection. In use cases that are sensitive to disconnections such as gaming and video calls, this delay can result in a suboptimal user experience. Accordingly, new approaches would be desired.

### BRIEF DESCRIPTION OF THE DRAWINGS

The disclosure may best be understood by referring to the following description and accompanying drawings that are used to illustrate embodiments. In the drawings:

FIG. 1 is a block diagram showing a compute platform with a network resilience utility in accordance with some embodiments.

FIG. 2 is a block diagram illustrating an approach for implementing a network resilience utility in accordance with some embodiments.

FIG. 3 is a flow diagram showing a routine for implementing network resilience in accordance with some embodiments.

FIG. 4 is a block diagram illustrating another approach for implementing a network resilience utility in accordance with some embodiments.

FIG. 5 is a flow diagram showing a routine for implementing network resilience in accordance with some embodiments.

### DETAILED DESCRIPTION

In some embodiments, techniques may be provided to facilitate rapid automatic access point (AP) steering and reverting between APs. For sensitive use cases such as gaming and video calls that require stable internet connections, disclosed approaches can provide fast and smooth transitions from a first (primary) AP to a second (alternate) AP during disconnections or substantial performance degradation. In this way, uninterrupted and high-quality user experiences may be maintained.

For example, in some embodiments, a compute platform (client such as PC or mobile device) may manage a network traffic routing table to cause data packets to be routed through the primary AP by default, with packets to the secondary AP used for internet verification. When the compute platform steers to the secondary AP, the routing table may be updated so that data packets are routed through the secondary AP, while packets to the primary AP are used for internet verification and/or to determine when the primary AP connection is once again valid, and when it is valid, revert back to the primary AP as the utilized AP.

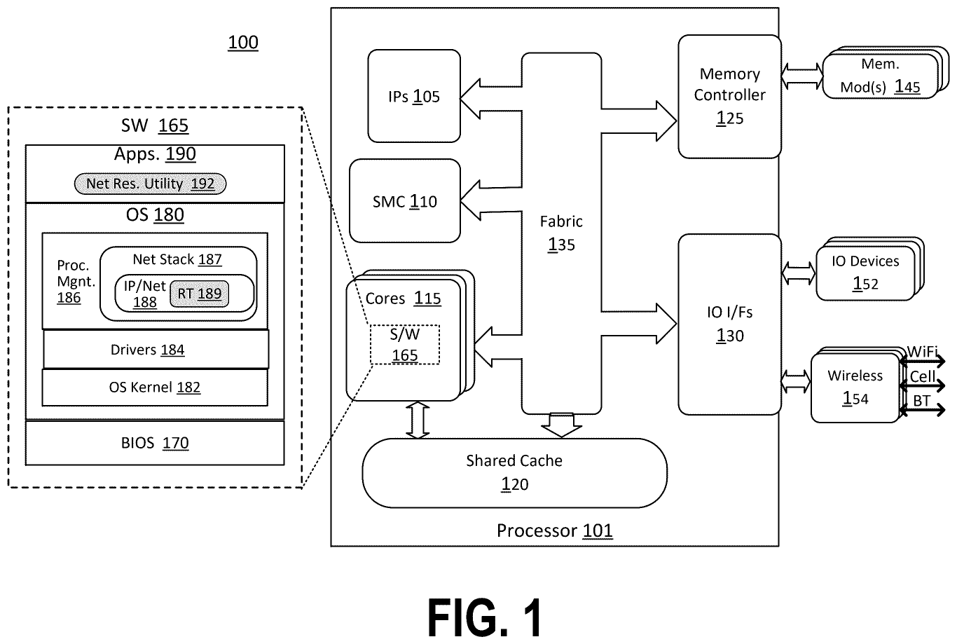

FIG. 1 is a block diagram showing a compute platform 100 with a network resilience utility in accordance with some embodiments. The compute platform may correspond to any type of compute system that is capable of processing code and wirelessly connecting with other compute platforms through one or more wireless networks such as WiFi, Bluetooth, and/or cellular networks. Such platforms may include but are not limited to personal computers (PCs), mobile handsets, smartphones, laptop computers, tablets, and the like.

The compute platform 100 includes a processor 101, along with other devices external to the processor. The processor includes IP (intellectual property) circuits 105, a system management controller (SMC) 110, processing cores 115, shared cash circuitry 120, a memory controller 125, IO interface circuits 130, and system fabric 135, all coupled together as shown. Also included are memory modules 145, IO devices 152, wireless component(s) 154, and software 165. (Note that a compute platform may have other devices such as power supplies, displays, cooling systems, etc., but they have not been expressly included with this description for ease of understanding.)

The processor 101 comprises at least one hardware circuit configured to execute instructions (e.g., in processing cores 115) contained in program code. The hardware circuit may be implemented with one or more integrated circuits. Examples of processor types that may be implemented with processor 101 include, but are not limited to, central processing units (CPUs), application processing units (APUs), graphics processing units (GPUs), system on chips (SOCs), and so forth. It should be appreciated that the compute platform including the processor 101 may be implemented in various different ways. For example, it may be implemented on a single die, multiple dies (dielets, chiplets), one or more dies in a common package, or one or more dies in multiple packages. Along these lines, some of the depicted blocks may be located separately on different dies or together on two or more different dies.

The IP circuits 105 are circuits that perform a particular function. An IP circuit (or IP) may be a unit of logic, circuit, cell, or chip layout that is reusable. A few examples of IP circuits include processor cores, memories, caches, floating point processors, memory controllers, bus controllers, graphics processors, transceivers, network interface controllers, and display controllers. One or more portions of a larger IP can themselves be designated as IP circuits. For example, an instruction execution unit and cache controller may be IP for a processor IP.

The SMC 110 includes one or more microcontrollers, state machines and/or other logic circuits for controlling various aspects of the processor 101. For example, it may manage functions such as security, boot configuration, and power and performance including utilized and allocated power along with thermal management. The SMC may also be referred to as a P-unit, a power management unit (PMU), a power control unit (PCU), a system management unit (SMU) and the like and may include multiple SMCs, PMUs, die management controllers, etc.

The processing cores 115 comprise cores for executing code in accordance with desired functionality for the compute platform and processor 101. They may comprise any suitable combination of core types such as compute (e.g., CPU) cores, graphics cores, parallel processing cores, vector processing cores, and the like, and may be implemented with differently sized core instances and/or by using the same or different instruction set architectures. Specific implementations will depend on functionality, as well as power and performance objectives.

The shared cache circuitry 120 includes one or more levels of cache memory, typically random access memory (RAM) that is used by the other blocks in the processor including the processor cores 115. Some or all of it may be part of an overall memory system that also includes the memory modules 145.

The memory controller(s) 125 is coupled to the memory modules 145. The memory modules are typically made up of DRAM memory chips, and each module may include a power delivery circuit and a memory module controller to interface between the raw memory and the memory controller 125. The memory may be implemented using any suitable type such as DDR double data rate), LPDDR (Low Power DDR), and the like. Accordingly, the channels that make up the memory channels operate in conformance with whatever memory type is being implemented.

The IO devices 152 and wireless components 154 are coupled to associated IO interfaces (or interface controllers) 130 to provide additional functionality and/or better performance capabilities. The IO interfaces may correspond to any suitable interface type, standard or proprietary, such as PCIe (Peripheral chip Interconnect express), USB (Universal Serial Bus), CXL (Compute Express Link), Mobile Industry Processor Interface (MIPI), Low-Voltage Differential Signaling (LVDS), and the like. The IO devices correspond to devices that may be connected with compute platforms such as peripherals, displays, graphics cards, non-volatile memory (flash, SSD), etc.

Likewise, the wireless components 154 correspond to wireless cards, chips, or chipsets (e.g., including radios, baseband processors, etc. for providing the compute platform with access to wireless networks including but not limited to WiFi, Bluetooth, cellular, etc. They may be used to connect the compute platform, for example, to the internet through wireless access points such as wireless (e.g., Wi-Fi™) routers or through other compute platforms acting as hot spot routers. This will be discussed further below with regard to implementation of network resilience utilities as disclosed herein.

The fabric 135 is a communications network of interconnected nodes to couple to one another the various different blocks of the processor 101. In some embodiments, it facilitates high-speed data transfer and communication, which allows for the creation of unified computing systems where the different components can work together. For convenience, a single overall fabric is shown, but fabric 135 may comprise multiple different fabrics and interconnection structures such as mesh and ring networks, as well as busses and point-to-point connections. In some embodiments, it may include separate different fabrics, e.g., a main data fabric for transferring data between the blocks and a control fabric for setting parameters, reading operational states, managing operating modes, communicating telemetry, and the like.

The software 165, which may be stored on the compute platform (e.g., on a solid-state disk-drive, flash, and/or ROM) and/or online, when called upon to be used by the platform, will likely be at least partially, if not wholly, executed by the processing cores 115. The compute platform software can be conceptualized as a layered structure generally including a BIOS 170, operating system (OS) 180, and applications layer 190. The applications (or apps) layer 190 sits atop the operating system (OS) layer 180, which in turn sits atop the BIOS 170.

The BIOS (basic input output system) 170 identifies, configures, tests, and connects computer hardware to the OS initially after a computer is turned on. After performing these tasks, the BIOS locates and loads the OS. (Note that as used herein, the terms BIOS and UEFI (Unified Extensible Firmware Interface, which is a specification for a way of implementing a BIOS, may be used interchangeably.)

The OS layer 180 generally includes a kernel 182, drivers 184, and process management components 186. The kernel 182 is the core of the operating system. It interfaces between software and hardware and controls the execution of other system components.

The device drivers 184 operate at a low level, often with the same privilege level as the OS kernel. They provide an abstraction of, and control interface to, the hardware for the OS and applications. They can also be programmed to perform other functions related to the hardware components to which they interface.

The process management components 186 handle the creation, execution, suspension, and termination of processes, as well as communication between them. Among other things, they perform memory, IO device, user interface (UI), network, security, and platform resource management. With particular relevance to this disclosure, the OS typically includes a network stack 187, which normally can be considered to be part of the process management components 186.

The network stack typically sits above the device drivers but below user applications. Operating systems often times use a network architecture, for example, that is based on the seven-layered Open Systems Interconnection (OSI) networking model. The model describes the network as a series of protocol layers with a specific set of functions allocated to each layer. Each layer offers specific services to higher layers while shielding these layers from the details of how the services are implemented. Among the seven different network stack layers is the network (or IP, internet Protocol) layer itself. This is represented in the figure as IP/Net 188. It is also sometimes referred to as “layer 3.” To avoid confusion, it will be referred to hence forth as the IP layer.

The IP layer 188 is responsible for routing data between different networks. It provides functional and procedural processes for transferring variable-length data sequences from a source host on one network to a destination host on a different network. The IP layer operates above the network stack's data link layer and below the transport layer. Among other things, it encapsulates data from upper layers into packets, adding source and destination IP addresses, and it enables communication between devices on different networks.

With logical addressing, the IP layer uses IP addresses to uniquely identify devices on a network and determine paths for conveying messages between sources and destinations. To do this, the IP layer typically employs a routing table, which is represented in the diagram at 189. The routing table, also known as the routing information base (RIB), is a data structure that includes information about network destinations and how to reach them. When a packet needs to be sent, the OS consults the routing table to determine the path to be taken. Among other things, the routing table includes entries that specify the destination network, subnet mask, gateway, and interface to use for different network routes. For Wi-Fi connections, the OS will typically have an entry in the routing table associated with the Wi-Fi interface.

For internet-bound traffic over Wi-Fi, operating systems commonly use a default route defined in a routing table that points to the Wi-Fi interface's gateway. With relevance to the features described herein, in cases where specific routes are desired, applications can be configured to add custom routes to the routing table using, for example, a route-add command. When receiving packets, the routing table may also be used to determine which interface should accept the incoming traffic.

The applications 190 are at the top of the stack and utilize the services provided by the lower layers. Applications interact with the hardware through the OS and drivers. In some embodiments, the applications 190 may include a network resilience utility (NRU) 192, as discussed more below, to maintain network connectivity through the use of fast-responding alternate WiFi interface monitoring and selection.

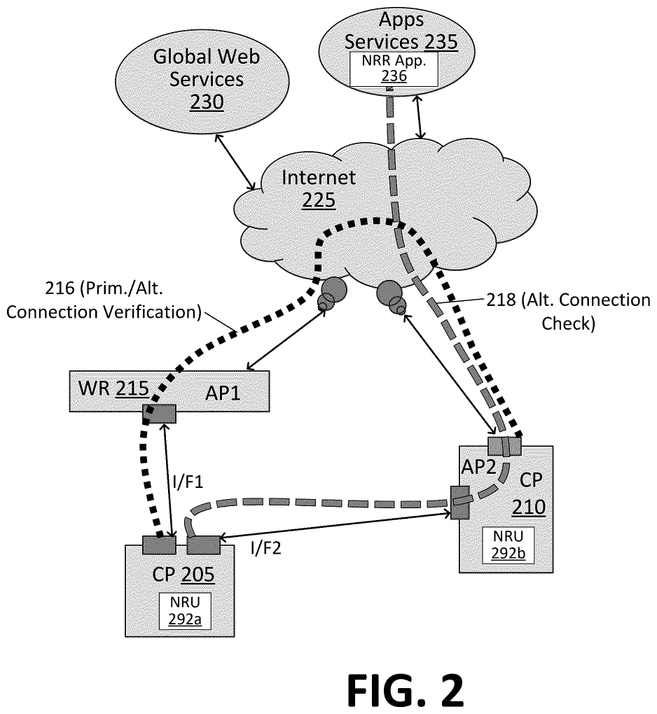

FIG. 2 is a block diagram illustrating an approach for implementing a network resilience utility using a compute platform hot spot for an alternate WiFi interface in accordance with some embodiments. With this example, there is a first compute platform (CP) 205, a second CP 210, a wireless router (WR) 215, internet infrastructure 225, global web services provider (WSP) servers 230, and App service servers 235, connected to one another as shown. With this example, the first and second CPs (205, 210) may be implemented with any suitable compute platform such as a PC and/or a mobile phone, so long as the second CP 210 is able to carry out wireless network (e.g., WiFi) hot spot functionality for the first CP 205.

Both the first and second CPs include net resilience utility (NRU) apps, 292a, 292b, respectively. The NRU apps may be implemented similarly or differently in terms of their specific functional capabilities, although NRU app 292a should be able to perform the functions of an NRU agent, while NRU 292b should be able to perform the functions of an NRR (net resilience response) agent. An NRU agent operates to monitor and maintain resilient internet connectivity for its compute platform (CP), which may have one or more agents maintaining one or more internet connections. On the other hand, a net resilience response (NRR) agent operates in cooperation with an associated NRU agent to provide it with a response such as an acknowledgement message in response to an NRU response request message.

With this example, the first CP 205 is connected to the internet through a primary WiFi interface (I/F1) and uses NRU 292a to maintain resilient connectivity with an alternate (or secondary) WiFi interface (I/F2) implemented by CP 210 functioning as a hot spot in this scenario. Thus, in some embodiments, both CPs may use similar NRU apps with the abilities to act as net resilience (NR) providers (as with 292a) or as NR responders (as with 292b). Alternately, separate apps could be used to facilitate these functions. In most cases, however, the user of the first CP (205) should have access to, or other rights with, the second CP when it is to serve as a responding NR agent.

The CP (e.g., PC) 205 employs two access points (AP1, AP2) using two virtual MAC (media access control) addressed interfaces (I/F1, I/F2) to connect to the internet. The I/F1 connection is through wireless router 215, functioning as a primary access point (AP1), while the I/F2 connection is through the second CP (210), functioning as an alternate access point (AP2). The NRU agent (in CP 205) manages its routing table (or equivalent) to cause data packets to be routed by default through the primary AP (AP1), and it sends response request messages to the alternate AP (AP2) through the internet for not only verifying the internet connection for I/F1, but also, for verifying that AP2 (through I/F2) is available if needed. This is represented with the hatched line at 216.

The response request message(s) are sent directly to CP 210, using its IP address, and once received, CP 210 responds back to CP 205 with an appropriate acknowledgement message. The response request messages should be sent at a sufficient rate (e.g., every few hundreds of milliseconds, in the range of 100 milliseconds to 300 milliseconds) to provide adequately continuous connectivity from a user experience perspective.

If the primary connection through AP1 fails, the CP (205) checks to confirm that the alternate AP (AP2, CP 210; in this case) has an operable connection to the internet. To do this, CP 205 sends a response request message through AP2 to a network resilience response agent (NRR agent), either using a public web service (e.g., Google™, Amazon™, etc.) 230 or a dedicated service application 236 on an internet server 235. A dedicated service application 236 can provide more reliable performance and better response times, although it may incur additional overhead to create and maintain the NRR apps for reliable service on an internet server. Alternately, existing available web services (e.g., Google™, Amazon, MSN™) may be employed, for example, by attempting to open a TCP port (such as HTTP) and confirming internet connectivity once a response is received. This option does not incur additional costs, but since it relies on general services, performance cannot be guaranteed.

Returning to FIG. 2, with this example, the NRU agent 292 uses the dedicated NRR application 236. This is illustrated with the dashed line at 218. If the AP 2 connection is valid, CP 205 updates its routing table to now steer its internet traffic through the alternate AP (AP2). (Noate that the term “valid” refers to a valid connectivity, which is a connectivity that enables access to an internet service.) At the same time, it may also send request response messages to the primary AP (AP1) through AP2 and the internet to determine if the AP1 connection once again becomes operable. If so, it may then switch back to AP1 as the primary access point and operate as described.

As used herein, a response request message is a TCP (transmission control protocol) message that can be sent efficiently to a net resilience response agent (e.g., on an internet server) and elicit an appropriate response message for the NRU agent to confirm a sound internet connection. The response request message should be such that it can pass through VPNs (virtual private networks), firewalls, and other internet servers without being blocked. For example, a response request message may be configured similarly to TCP keepalive messages in that they can operate within an established TCP connections, and they are typically smaller, for example, compared to ping packets. TCP packets are often allowed through firewalls and network filters, especially if they are part of an established connection or if the firewall is configured to allow traffic on specific ports. The response request message may be used to maintain an open connection even when there is no active data being transmitted.

In some embodiments, a response request message over TCP/IP connections may have an empty payload, or it may contain a small amount of data, e.g., for verifying that the connection is still active and to prevent the connection from timing out. An NRU app should control response request messages to be conveyed at an interval that is long enough to prevent excessive network and processing overhead for the CP user but short enough to maintain the connection and to give the NR sufficient time to switch to the alternate connection if the primary connection is lost.

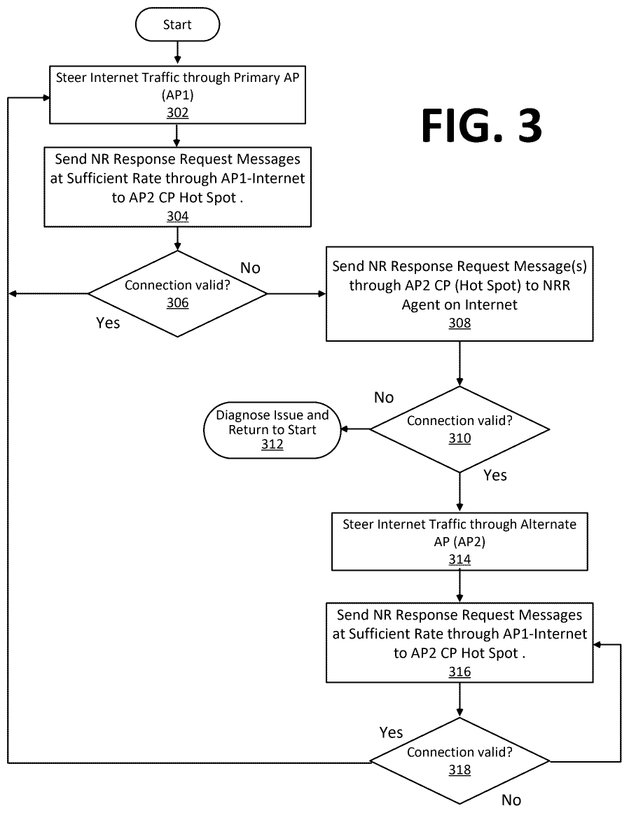

FIG. 3 is a flow diagram showing a routine for implementing network resilience with an associated compute platform as a hot spot for an alternate access point in accordance with some embodiments. For example, this routine may be performed by a network resilience utility as described herein.

At 302, the routine directs its agent's internet traffic through a primary AP (AP1). The agent may correspond to one or more internet connected applications (e.g., browser, game, stream feed) in a compute platform such as a PC, a server, or a mobile device. At 304, it sends NR response request messages at a sufficient rate through a primary access point (AP1) to an alternate AP (AP2) through the internet. At 306, it checks to confirm whether the connection is valid. For example, a flag may be set if an expected response to the last response request message is timely received. If the connection is valid, the routine loops back to 302 and continues steering internet traffic through the primary AP.

If the connection was not valid, then it proceeds to 308 and sends a NR response request message(s) through the alternate I/F (CP hot spot AP) to a NRR agent on the internet. From here, it goes to 310 and determines if this connection is valid. If not, then at 312, it takes action to have the issue diagnosed, e.g., notify user, and once redressed, returns back to the start of the routine. If the connection was valid, then it proceeds to 314 and causes internet traffic for its CP agent to be steered through the alternate AP instead of the primary AP.

At 316, it once again sends (or attempts to send) NR response request messages, at a sufficient rate, through the primary AP (AP1) to the alternate AP (CP hot spot) over the internet to check and determine if and when the primary AP connection becomes active. This occurs while the CP agent continues using the alternate AP for its internet traffic. From here, the routine goes to 318 and determines if the connection is valid. If not, it loops back to 316 and continues sending NR response request messages until the AP1 connection is once again active. When the connection does come back, the routine, at 318, returns back to 302, switching internet traffic once again back through the primary access point (AP1).

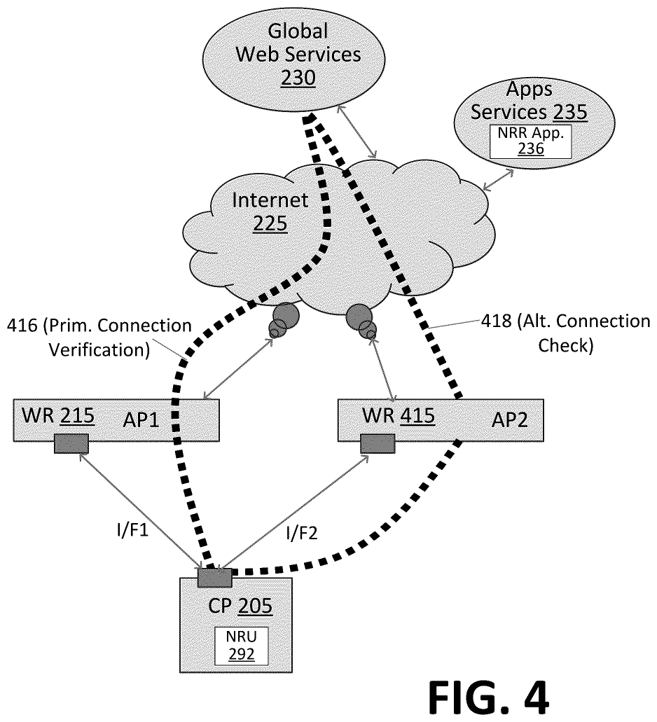

FIG. 4 is a block diagram illustrating another approach for implementing a network resilience utility using a second wireless router as an alternate access point in accordance with some embodiments. This network configuration is similar with that of FIG. 2 except that a second wireless router (WR 415) is used as the alternate AP (AP2) rather than a compute platform hot spot. With this configuration, to identify fast disconnection from the primary AP (WR 215), the CP (205) through its NRU agent 292, sends NRU response request messages (e.g. every 100 mS) to an NRR agent. With the depicted example, it sends the messages to an NRR agent that is part of an existing publicly available web service 230. This is depicted by the dashed line at 416.

If the primary AP (AP1) NRU response request message fails, then the CP sends NRU response request messages through the secondary AP to the NRR agent. This is depicted by the dashed line at 418. If the response request message succeeds, the CP steers to the alternate AP (AP2). In some embodiments, the CP reverts back to the primary AP when response request messages from the CP through the primary AP to the NRR agent arrives, and responds, successfully.

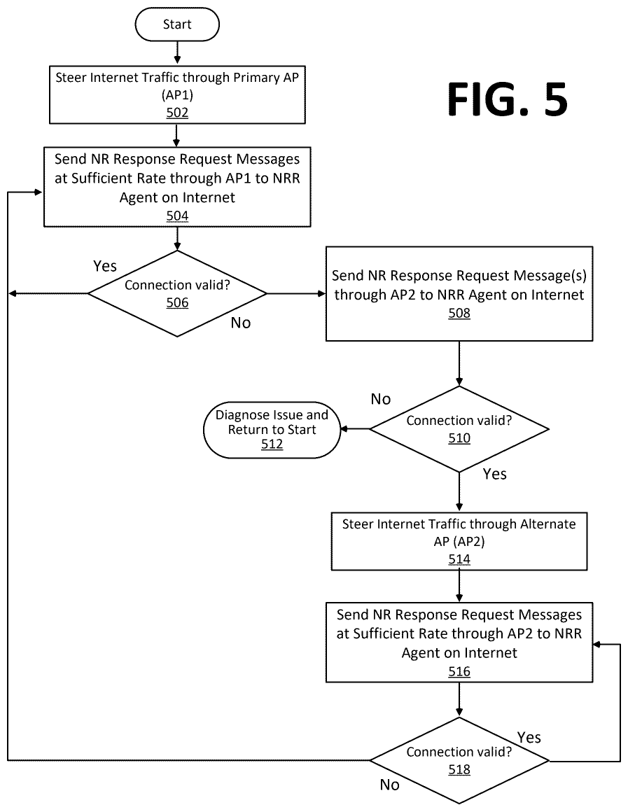

FIG. 5 is a flow diagram showing a routine for implementing network resilience with a second wireless router as an alternate access point in accordance with some embodiments. For example, this routine may be performed by a network resilience utility as described herein. At 502, the routine directs its CP agent's internet traffic through a primary AP (AP1). The agent, which serves CP 205, may correspond to one or more internet connected applications (e.g., browser, game, stream feed) in a compute platform such as a PC, a server, or a mobile device.

At 504, it sends NR response request messages at a sufficient rate through the primary access point (AP1) to an NRR agent on the internet. At 506, it checks to confirm whether the connection is valid. For example, a flag may be set if an expected response to the last response request message is timely received. If the connection is valid, the routine loops back to 504 and continues steering internet traffic through the primary AP. If the connection was not valid, then it proceeds to 508 and sends an NRU response request message(s) through the alternate I/F (AP2) to an NRR agent on the internet. From here, it goes to 510 and determines if this connection is valid. If not, then at 512, it takes action to have the issue diagnosed, e.g., notify user, and once redressed, returns back to the start of the routine.

If the connection was valid, however, then it proceeds to 514 and causes internet traffic for its CP agent to be steered through the alternate AP instead of the primary AP. At 516, it sends NR response request messages, at a sufficient rate, through the alternate AP (AP2) to the alternate AP (CP hot spot) over the internet to check and confirm that the alternate AP connection is sound. This occurs while the CP agent continues using the alternate AP for its internet traffic. From here, the routine goes to 518 and confirms that the connection is valid. If it is valid, the routine loops back to 316 and continues sending NR response request messages confirming the internet connection through AP2 is valid, if and until the AP2 connection fails. If/when the AP2 connection fails, the routine loops back to 502 and proceeds as described.

Note that alternatively as with the routine of FIG. 3, instead of staying with AP2 so long as it is valid, the routine could send response request messages through both APs, sending messages through AP2 to ensure the connection remains valid and sending messages through AP1 to determine if the connection comes back and then switching back if it becomes valid again.

Illustrative examples of the technologies disclosed herein are provided below. An embodiment of the technologies may include any one or more, and any compatible combination of, the examples described below.

Example 1 is a non-transitory computer readable storage medium including instructions that when executed by a compute platform perform a method. The method includes: routing user application internet traffic between the compute platform (CP) and an internet through a first access point (AP) in a first connection, sending response request messages through the first AP and the internet to an alternate AP to receive from the alternate AP response messages to determine if the first connection fails, and routing the internet traffic through the alternate AP in response to determining the first connection failed and determining a second connection to the internet through the alternate AP is valid.

Example 2 includes the subject matter of example 1, and wherein routing internet traffic through the first AP includes designating the first AP as a default AP in a routing table for the CP.

Example 3 includes the subject matter of any of examples 1-2, and wherein the alternate AP is a second compute platform serving as a WiFi hot spot.

Example 4 includes the subject matter of any of examples 1-3, and wherein the response request messages are transmission control protocol (TCP) conforming messages that include an IP address to the alternate AP.

Example 5 includes the subject matter of any of examples 1-4, and wherein sending response request messages includes sending a response request message every few hundreds of milliseconds in the range of 100 milliseconds to 300 milliseconds.

Example 6 includes the subject matter of any of examples 1-5, and wherein sending response request messages includes sending the response request messages through the first connection while the user application internet traffic is also being conveyed through the first connection.

Example 7 includes the subject matter of any of examples 1-6, and wherein the user application includes at least one of an internet browser, game, or video conference application.

Example 8 includes the subject matter of any of examples 1-7, and wherein determining if the second connection to the internet through the alternate AP is valid includes sending response request messages from the CP through the alternate AP to a response agent on the internet.

Example 9 includes the subject matter of any of examples 1-8, and wherein routing the internet traffic through the alternate AP includes sending response request messages through the first AP and the internet to the alternate AP to receive from the alternate AP response messages to determine if the first connection becomes valid while the internet traffic is being routed through the alternate AP.

Example 10 includes the subject matter of any of examples 1-9, and comprising routing the internet traffic through the first AP responsive to the first connection becoming valid.

Example 11 is a non-transitory computer readable storage medium including instructions that when executed by a compute platform perform a method. The method comprises: routing user application internet traffic between the compute platform (CP) and an internet through a first access point (AP) in a first connection, sending response request messages through the first connection to a first response agent on the internet to receive from the first response agent response messages to confirm that the first connection is valid, sending response request messages through an alternate AP in a second connection to a second response agent on the internet to receive from the second response agent response messages to confirm that the second connection is valid, and routing the internet traffic through the alternate AP in response to determining the first connection failed and determining the second connection is valid.

Example 12 includes the subject matter of example 11, and wherein sending response request messages through the alternate AP in the second connection is responsive to confirming the first connection is not valid.

Example 13 includes the subject matter of any of examples 11-12, and wherein the alternate AP is a wireless router.

Example 14 includes the subject matter of any of examples 11-13, and wherein the response request messages are transmission control protocol (TCP) conforming messages that include an IP address to the alternate AP.

Example 15 includes the subject matter of any of examples 11-14, and wherein sending response request messages includes sending a response request message at least every 500 milli-seconds.

Example 16 includes the subject matter of any of examples 11-15, and wherein sending response request messages includes sending the response request messages through the first connection while the user application internet traffic is also being conveyed through the first connection.

Example 17 includes the subject matter of any of examples 11-16, and wherein the user application includes at least one of an internet browser, game, or video conference application.

Example 18 includes the subject matter of any of examples 11-17, and comprising routing the internet traffic back through the first AP responsive to the first connection becoming valid.

Example 19 is a compute platform apparatus that includes a processor, a wireless component coupled to the processor to provide the compute platform with wireless access to an internet, and a memory. The memory includes instructions that when executed by the processor perform a method including: routing user application internet traffic between the compute platform (CP) and the internet through a first access point (AP) in a first connection, sending response request messages through the first AP and the internet to an alternate AP to receive from the alternate AP response messages to determine if the first connection fails, and routing the internet traffic through the alternate AP in response to determining the first connection failed and determining a second connection to the internet through the alternate AP is valid.

Example 20 includes the subject matter of example 19, and wherein routing internet traffic through the first AP includes designating the first AP as a default AP in a routing table for the CP.

Example 21 includes the subject matter of any of examples 19-20, and wherein the alternate AP is a second compute platform serving as a WiFi hot spot.

Example 22 includes the subject matter of any of examples 19-21, and wherein the response request messages are transmission control protocol (TCP) conforming messages that include an IP address to the alternate AP.

Example 23 includes the subject matter of any of examples 19-22, and wherein sending response request messages includes sending a response request message at least every 500 milli-seconds.

Example 24 includes the subject matter of any of examples 19-23, and wherein sending response request messages includes sending the response request messages through the first connection while the user application internet traffic is also being conveyed through the first connection.

Example 25 includes the subject matter of any of examples 19-24, and wherein the user application includes at least one of an internet browser, game, or video conference application.

Example 26 includes the subject matter of any of examples 19-25, and wherein determining if the second connection to the internet through the alternate AP is valid includes sending response request messages from the CP through the alternate AP to a response agent on the internet.

Example 27 includes the subject matter of any of examples 19-26, and wherein routing the internet traffic through the alternate AP includes sending response request messages through the first AP and the internet to then alternate AP to receive from the alternate AP response messages to determine if the first connection becomes valid while the internet traffic is being routed through the alternate AP.

Example 28 includes the subject matter of any of examples 19-27, and comprising routing the internet traffic through the first AP responsive to the first connection becoming valid.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included.

The meaning of “in” includes “in” and “on” unless expressly distinguished for a specific description.

The terms “substantially,” “close,” “approximately,” “near,” and “about,” unless otherwise indicated, generally refer to being within +/−10% of a target value.

Unless otherwise specified, the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner

For the purposes of the present disclosure, phrases “A and/or B” and “A or B” mean (A), (B), or (A and B). For the purposes of the present disclosure, the phrase “A, B, and/or C” means (A), (B), (C), (A and B), (A and C), (B and C), or (A, B and C).

It is pointed out that those elements of the figures having the same reference numbers (or names) as the elements of any other figure can operate or function in any manner similar to that described but are not limited to such.

In the drawings of the embodiments, signals are represented with lines. Some lines may appear different from others, for example, thicker or hatched, to distinguish from other depicted signals for ease of understanding. Along these lines, some signal lines may have arrows at one or more ends, to indicate a primary direction of information flow. However, such indications are not intended to be limiting. Rather, lines are used in connection with one or more exemplary embodiments in a given figure to facilitate easier understanding of concepts embodied in block, circuit, and/or flow diagrams. Any represented signal, as dictated by design needs or preferences, may actually comprise one or more signals that may travel in either direction and may be implemented with any suitable type of signal scheme, e.g., analog, digital, wired, wireless, upon the platform within which the present disclosure is to be implemented.

As defined herein, the term “computer readable storage medium” means a storage medium that contains or stores program code for use by or in connection with an instruction execution system, apparatus, or device. As defined herein, a “computer readable storage medium” is not a transitory, propagating signal per se. A computer readable storage medium may be, but is not limited to, an electronic storage device, a magnetic storage device, an optical storage device, an electromagnetic storage device, a semiconductor storage device, or any suitable combination of the foregoing. Memory elements, as described herein, are examples of a computer readable storage medium.

As defined herein, the term “processor” means at least one hardware circuit configured to carry out instructions contained in program code. The hardware circuit may be implemented with one or more integrated circuits. Examples of a processor include, but are not limited to, a central processing unit (CPU), an application processing unit (APU), a system on a chip (SOC), a field-programmable gate array (FPGA), a programmable logic array (PLA), an application specific integrated circuit (ASIC), programmable logic circuitry, a graphics processing unit (GPU), a controller, and so forth.

It should be appreciated that a processor or processor system may be implemented in various different manners. For example, they may be implemented on a single die, multiple dies (dielets, chiplets), one or more dies in a common package, or one or more dies in multiple packages. Along these lines, some of these blocks may be located separately on different dies or together on two or more different dies.

While the flow diagrams in the figures show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A non-transitory computer readable storage medium including instructions that when executed by a compute platform causes the compute platform to:
route user application internet traffic between the compute platform and an internet through a first access point in a first connection;
send response request messages through the first access point and the internet to an alternate access point;
receive from the alternate access point response messages to determine if the first connection fails; and
routing the internet traffic through the alternate access point in response to determining the first connection failed and determining a second connection to the internet through the alternate access point is operable.

2. The storage medium of claim 1, wherein routing internet traffic through the first access point includes designating the first access point as a default access point in a routing table for the compute platform.

3. The storage medium of claim 1, wherein the alternate access point is a second compute platform serving as a wireless hot spot or a wired router that is part of a local area network (LAN).

4. The storage medium of claim 1, wherein the response request messages are transmission control protocol (TCP) conforming messages that include an IP address to the alternate access point.

5. The storage medium of claim 4, wherein sending response request messages includes sending a response request message at least every 500 milli-seconds.

6. The storage medium of claim 4, wherein sending response request messages includes sending the response request messages through the first connection while the user application internet traffic is also being conveyed through the first connection.

7. The storage medium of claim 1, wherein the user application includes at least one of an internet browser, game, or video conference application.

8. The storage medium of claim 1, wherein determining if the second connection to the internet through the alternate access point is operable includes sending response request messages from the compute platform through the alternate access point to a response agent on the internet.

9. The storage medium of claim 1, wherein routing the internet traffic through the alternate access point includes sending response request messages through the first access point and the internet to the alternate access point to receive from the alternate access point response messages to determine if the first connection becomes operable while the internet traffic is being routed through the alternate access point.

10. The storage medium of claim 9, comprising switching the routing of the internet traffic back through the first access point responsive to the first connection becoming operable.

11. A non-transitory computer readable storage medium including instructions that when executed by a compute platform causes the compute platform to:
route user application internet traffic between the compute platform and an internet through a first access point in a first connection;
send response request messages through the first connection to a first response agent on the internet to receive from the first response agent response messages to confirm that the first connection is valid;
send response request messages through an alternate access point in a second connection to a second response agent on the internet to receive from the second response agent response messages to confirm that the second connection is valid; and
route the internet traffic through the alternate access point in response to determining the first connection failed and determining the second connection is valid.

12. The storage medium of claim 11, wherein sending response request messages through the alternate access point in the second connection is responsive to confirming the first connection is not valid.

13. The storage medium of claim 11, wherein the alternate access point is a wireless router.

14. The storage medium of claim 11, wherein the response request messages are transmission control protocol (TCP) conforming messages that include an IP address to the alternate access point.

15. The storage medium of claim 14, wherein sending response request messages includes sending the response request messages through the first connection while the user application internet traffic is also being conveyed through the first connection.

16. The storage medium of claim 11, comprising switching routing of the internet traffic back through the first access point responsive to the first connection becoming valid.

17. A compute platform apparatus, comprising:
a processor;
a wireless device coupled to the processor to provide the compute platform with wireless access to an internet; and
a memory including instructions that when executed by the processor:
routes user application internet traffic between the compute platform and the internet through a first access point in a first connection,
sends response request messages through the first access point and the internet to an alternate access point to receive from the alternate access point response messages to determine if the first connection fails, and
routes the internet traffic through the alternate access point in response to determining the first connection failed and determining a second connection to the internet through the alternate access point is valid.

18. The apparatus of claim 17, wherein routing internet traffic through the first access point includes designating the first access point as a default access point in a routing table for the compute platform.

19. The apparatus of claim 17, wherein the alternate access point is a second compute platform serving as a WiFi hot spot.

20. The apparatus of claim 17, wherein the response request messages are transmission control protocol conforming messages that include an IP address to the alternate access point.
